(19) United States
(12) Patent Application Publication
(10) Pub. No.: US 2004/0054684 A1
(43) Pub. Date: Mar. 18, 2004

(54) Method and system for determining sample preparation parameters

(76) Inventor: Kay Geels, Birkerod (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/416,012

(22) PCT Filed: Nov. 12, 2001
(86) PCT No.: PCT/DK01/00743

(30) Foreign Application Priority Data
Nov. 13, 2000 (DK) PA 2000 01697

(51) Int. Cl. G06F 17/00

(52) U.S. Cl. 707/102

(57) ABSTRACT

A system and a method for determining sample preparation parameters for use in the preparation of metallographic samples with suitable sample preparation equipment; the system comprises first input means (4a) for inputting input values for a set of preparation criteria; first storage means (2, 6) adapted to store a plurality of preparation criteria and a plurality of sample preparation method parameters; processing means (3) adapted to calculate a set of sample preparation method parameters based on the input values and the stored sample preparation method parameters; output means (4a) for the output of the calculated set of sample preparation method parameters; second input means (4b) for receiving adapted sample preparation method parameters; and second storage means (2) adapted to store the adapted sample preparation method parameters for subsequent retrieval by the processing means in connection with a subsequent determination of sample preparation method parameters requested by an authorised operator.

This invention relates to the preparation of metallographic samples and, more particularly, to the determination of suitable sample preparation processes.

The preparation of metallographic samples is a time-consuming task and may comprise a variety of steps, such as mounting, grinding, polishing, etching or the like. Each step may further be characterised by a number of process parameters, such as the type of equipment used, the type and dosing of lubricants, the type and grain size of the polishing material, force, speed, time or the like. The result of the sample preparation, and thus the quality of any subsequent sample analysis, depends critically upon the preparation method employed. Furthermore, there is a vast variety of possible materials, and the intended purpose of the sample preparation may also vary considerably from for example quality or process control to the measurement of physical properties, the identification of phases or inclusions or the like. Different materials and different purposes may imply different requirements for the sample preparation. All this implies that the determination of a suitable sample preparation method is an extremely complex task with a large number of degrees of freedom.

Therefore, there is a need for methods and a systems that allow an efficient and uniform determination of sample preparation methods.

U.S. Pat. No. 4,992,948 discloses a data processing unit for controlling a machine tool including a data base containing data regarding the machine tool, possible work pieces, tools insertable into the machine tool, and individual processing methods. In operation, an operator enters data regarding the material of a work piece, the type of tool and the surface quality desired of the article to be produced. The data processing unit determines one or more suitable sets of machining data based on a set of stored subroutines.

However, the above prior art system involves the problem that, as the result of a metallographic sample preparation is sensitive to the preparation method employed, frequent adaptations to standard sample preparation methods are necessary in order to optimise the results for a specific sample, a specific objective of the preparation, or for the available equipment. These adaptations often comprise a considerable amount of testing based on a standard method and the individual metallographer's experience. For this reason a uniform quality of the preparation is difficult to maintain. In particular, this is an issue for the manufacturer of sample preparation equipment who is required to support a large number of customers with varying quality requirements, sample characteristics and preparation equipment.

According to a first aspect of the invention, the above and other problems are solved by a system for determining sample preparation parameters for use in the preparation of a sample of a material, the preparation comprising the use of at least one sample preparation device, the system comprising

first input means for receiving input values for a set of preparation criteria;

first storage means adapted to store a plurality of preparation criteria and a plurality of sample preparation method parameters;

processing means adapted to determine a set of sample preparation method parameters based on the input values and the stored sample preparation method parameters; and

output means adapted to output the determined set of sample preparation method parameters, is characterised in that the system further comprises

second input means for receiving adapted sample preparation method parameters; and

second storage means adapted to store the adapted sample preparation method parameters for subsequent retrieval by the processing means in connection with a subsequent determination of sample preparation method parameters requested by an authorised operator.

Consequently, when a metallographer has determined a more suitable preparation method for a given sample he/she may input the new method as adapted method parameters into the system according to the invention. The adapted method parameters are stored, thereby being available for subsequent calculations of method parameters. Hence, when a laboratory receives another similar sample, the system will be able to determine a more suitable choice of method, thereby saving considerable testing time and resources and reducing the reliance on individual metallographers' experience.

It is a further advantage of the invention that it allows repeated preparation of samples of the same or similar types with reproducible results.

The first input means and the output means may be separate or, preferably, the same computer, preferably with a keyboard, a display screen and a pointing device. This computer may also comprise the first storage means, for example a database system, and the processing means. Alternatively, it may be a client computer connected to a server computer which comprises the processing means, the first storage means or both.

The material to be prepared may be any material which may be subject to metallographic analysis, for example solid materials, such as ferrous metals such as steels, iron, alloys or powder metals, or non ferrous metals such as aluminium, copper, chrome, or molybdenum, or ceramics, sintered carbides, composites, electronic parts, plastics, precious metals, mineralogical materials such as concrete, biological samples or the like.

It is an advantage of the invention that it provides a system for accumulating, maintaining and querying a large knowledge base of sample preparation methods.

It is a further advantage of the invention that it gives access to a large number of sample preparation methods in a searchable database with a variety of possible search criteria, such as sample characteristics, available equipment or quality requirements.

It is a further advantage of the invention that it allows the calculation of suitable preparation method parameters based upon a search criterion and the stored preparation methods.

It is yet another advantage of the invention that it reduces the need for long testing periods for the establishment of a correct preparation process for samples which have not earlier been prepared.

In a preferred embodiment the set of preparation criteria comprises a set of sample properties and identifications of the sample preparation device. Furthermore, the sample preparation method parameters may comprise process step identifications, as the process may comprise a plurality of steps. The sample preparation method parameters may further comprise sample preparation device identifications and process parameters.

The sample properties may comprise a material name or identifier, shape and dimensions, hardness, the condition and pre-treatment of the material, etc.

The process steps may comprise mounting, cutting, grinding, polishing and etching steps and any combination thereof.

The sample preparation device identifications may comprise equipment type and configuration, such as the type of grinding, polishing, cutting equipment, etc.

Process parameters may comprise any process requirements such as duration, standard processes and procedures or the like.

This gives the advantage that the calculated sample preparation parameters may be adapted to a specific type of sample, a specific machine, such as a specific type of grinding or polishing equipment, specifics of the grinding or polishing materials, such as grain size or the like, or process parameters such as speed, force duration, etc.

When the sample properties comprise quality requirements for the prepared sample, the calculated method parameters may also be adapted to the desired use of the sample.

Different methods may be preferable for an analysis for inclusions than for hardness measurements, etc.

In a preferred embodiment of the invention, the second input means is further adapted to receive adapted preparation criteria, and the second storage means is adapted to store the adapted preparation criteria. Consequently, an operator may, via a suitable user interface, further input adapted preparation criteria back into the system which are more suitable for describing the actual sample and/or preparation requirements. Hence, in a subsequent query for a similar sample, more suitable method parameters may be determined

Frequent adaptations to standard sample preparation methods are necessary in order to optimise the results for a specific sample, a specific objective of the preparation, or for the available equipment. However, these adaptations are difficult to transfer to other laboratories, which may use different types of sample preparation equipment.

According to another preferred embodiment of the invention, the system further comprises editing means adapted to allow an authorised user to edit at least the adapted sample preparation method parameters stored in the second storage means and to store the edited data in said first storage means. It is an advantage of this embodiment that the adapted preparation methods may be reviewed and possibly edited by an authorised user, for example an expert metallographer. Upon approval of the method, it may be stored as part of the existing preparation methods in the first storage means, thereby making them available to all users. According to this embodiment, the adapted method parameters stored in the second storage means are only available to a selected group of operators, e.g. metallographers of a certain laboratory, a certain department, etc.

For example, the editing means may comprise a computer with a display providing a user-interface for viewing method parameters, editing them, etc. The user-interface may further provide functionality for storing approved method parameters in the first storage means.

It is a further advantage of the invention that a new preparation method, once it is established at one site, may be made available at other sites with little delay, thus saving testing time and cost.

It is yet a further advantage of the system that new methods are made generally available only after approval of the method by an authorised user, thereby increasing the reliability of the system.

In a preferred embodiment the sample preparation device is connected to said output means via a communications interface and adapted to receive said calculated sample preparation method parameters. The communications interface may be any suitable interface for example via a serial or parallel connection, a wireless connection, a communications network such as a local area network or the like. This gives the advantage that calculated preparation method parameters may be transmitted directly to one or more selected preparation devices, and the sample preparation process may even be controlled from a single computer. A less efficient and error-prone manual transfer of parameters may thus be avoided.

According to another preferred embodiment of the invention, the system comprises a server data processing system and a client data processing system connected via a communications network, the client data processing system including the first input means, the output means, and means for sending a request to the server data processing system via the communications network, the request comprising the input values; and the server data processing system including the first storage means and the processing means. The communications networks may be any suitable communications network, such as a local area network, a virtual private network, the Internet, a dedicated dial-up connection or the like. This gives the advantage that a central database of existing and approved preparation methods may be maintained, while the local laboratories have access to the database via a client system, for example a computer running a client program, such as a browser. The processing means for the calculation of the method parameters may be located on the server side or on the client side, or it may be distributed between both sides. In one embodiment, the client data processing system further comprises the second storage means. Hence, the adapted preparation methods are stored locally.

In a further preferred embodiment the processing means is adapted to interpolate between the sample preparation method parameters stored in said first storage means. This gives the advantage that if a combination of two existing methods is most suitable, such a combination may be calculated. For example, existing methods may be based upon equipment which is not available at a given site. In this case a proposed set of process parameters for the available equipment may be calculated on the basis of the known methods.

According to a second aspect of the invention the above and other objects are achieved when a method of determining sample preparation parameters for use in a preparation of a sample of a material, the preparation comprising the use of at least one sample preparation device, the method comprising the steps of

receiving input values for preparation criteria;

determining a set of sample preparation method parameters based on the input values and a plurality of sample preparation method parameters stored in a first storage means;

outputting the set of sample preparation method parameters on a first output means, is characterised in that the method further comprises the step of storing an adapted set of sample preparation method parameters in a second storage means for subsequent retrieval in connection with a subsequent determination of sample preparation method parameters requested by an authorised operator.

In a preferred embodiment the method further comprises the steps of

processing the second set of sample preparation parameters by a supervisor; and

storing the processed set of sample preparation method parameters in the first storage means.

The invention further relates to a server data processing system for determining sample preparation parameters for use in a preparation of a sample of a material, the preparation comprising the use of at least one sample preparation device, the server data processing system comprising

means for receiving a request from a client data processing system via a communications network, the request including input values for a set of preparation criteria;

first storage means adapted to store a plurality of preparation criteria and a plurality of sample preparation method parameters;

processing means adapted to determine a set of sample preparation method parameters based on the input-values and the stored sample preparation method-parameters; and

means for sending a response to the client data processing system including the determined set of sample preparation method parameters;

characterised in that the server data processing system further comprises

means for receiving a request including adapted sample preparation method parameters; and

second storage means adapted to store the adapted sample preparation method parameters for subsequent retrieval by the processing means in connection with a subsequent determination of sample preparation method parameters requested by an authorised operator.

The invention further relates to a client data processing system for determining sample preparation parameters for use in a preparation of a sample of a material, the preparation comprising the use of at least one sample preparation device, the server data processing system comprising

first input means for receiving input values for a set of preparation criteria;

means for sending a request to a server data processing system via a communications network, the request including the input values;

means for receiving a response from the server data processing system including a set of sample preparation method parameters determined based on the input values as well as a plurality of preparation criteria and a plurality of sample preparation method parameters stored in a first storage means of the server data processing system;

characterised in that the client data processing system further comprises

second input means for receiving adapted sample preparation method parameters; and

second storage means adapted to store the adapted sample preparation method parameters for subsequent retrieval by the processing means in connection with a subsequent determination of sample preparation method parameters requested by an authorised operator.

The invention will be explained more fully below in connection with preferred embodiments and with reference to the drawings, in which:

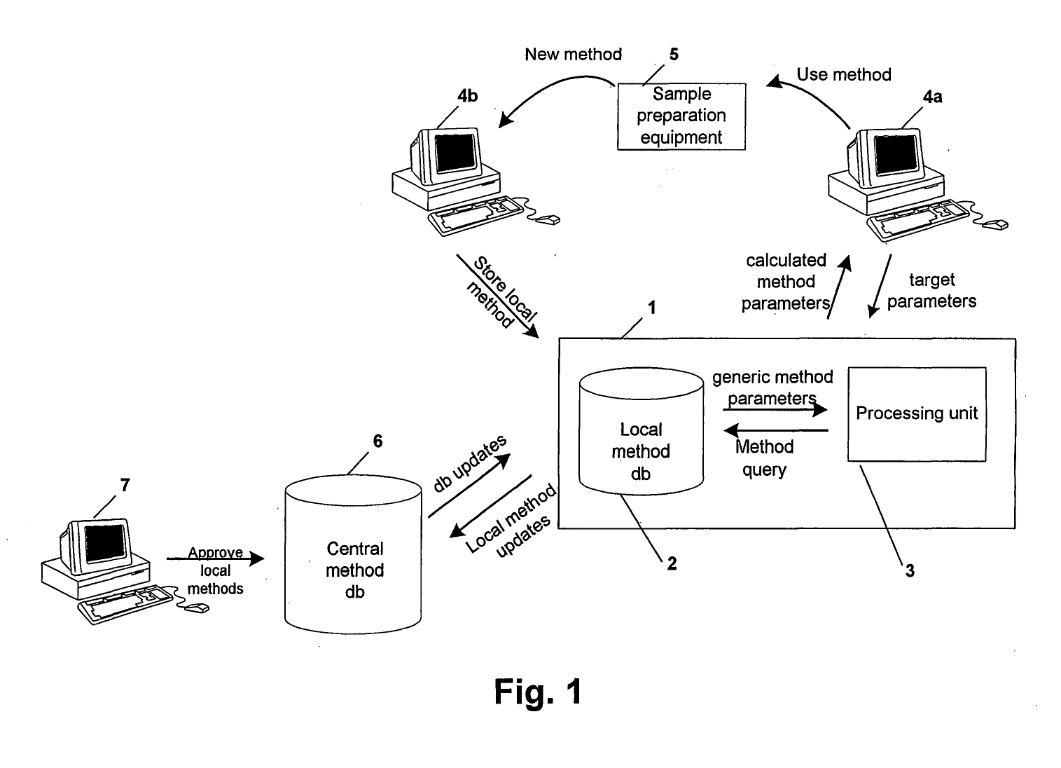

FIG. 1 shows a schematic view of a first embodiment of the invention;

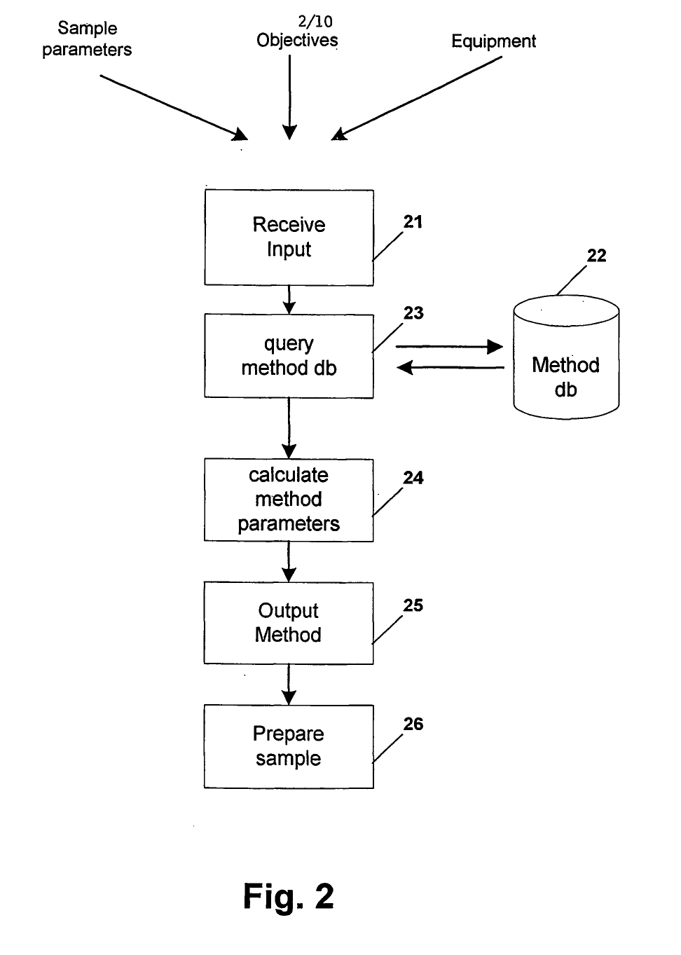

FIG. 2 shows a schematic flow diagram of the determination of a preparation method according to a second embodiment of the invention;

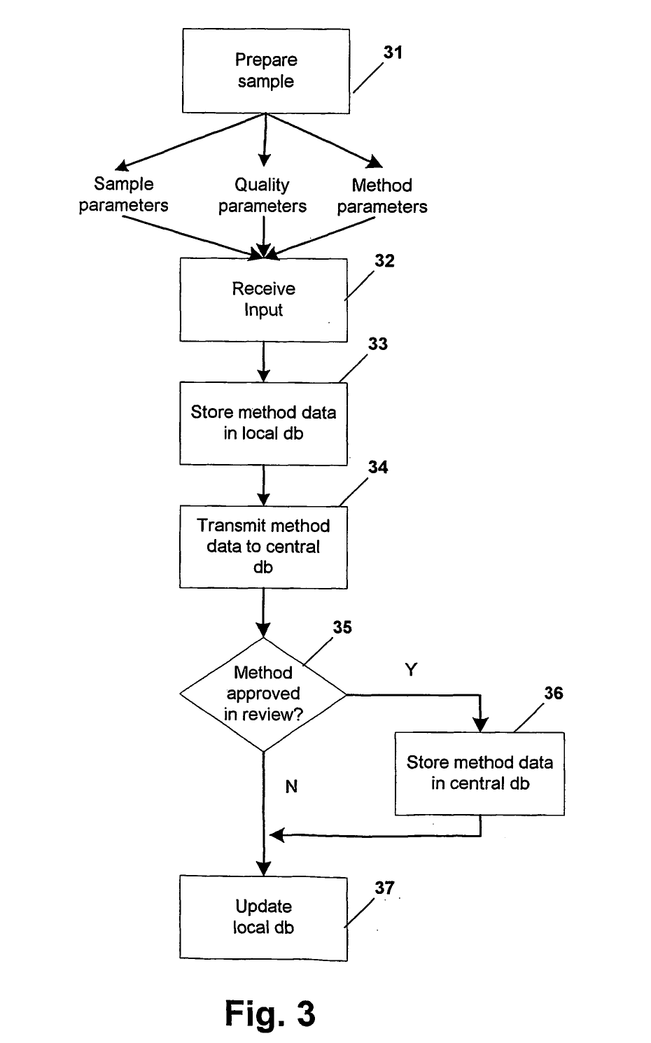

FIG. 3 shows a schematic flow diagram of the adaptation of preparation methods according to the second embodiment of the invention;

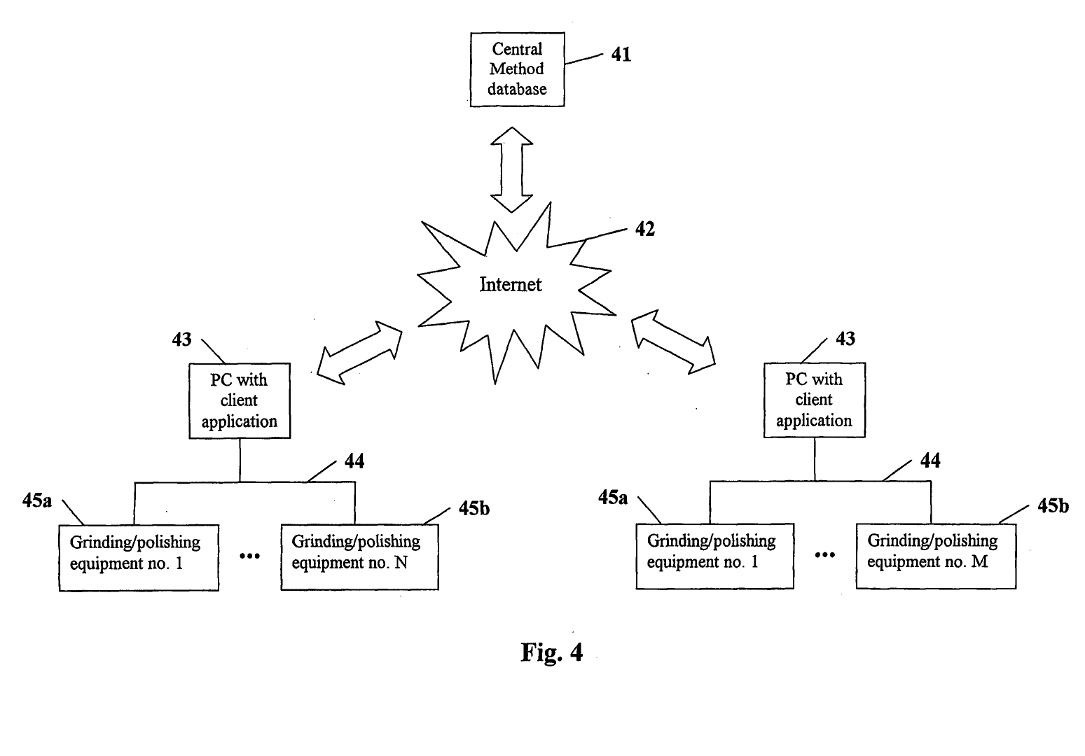

FIG. 4 schematically shows a third embodiment of the invention;

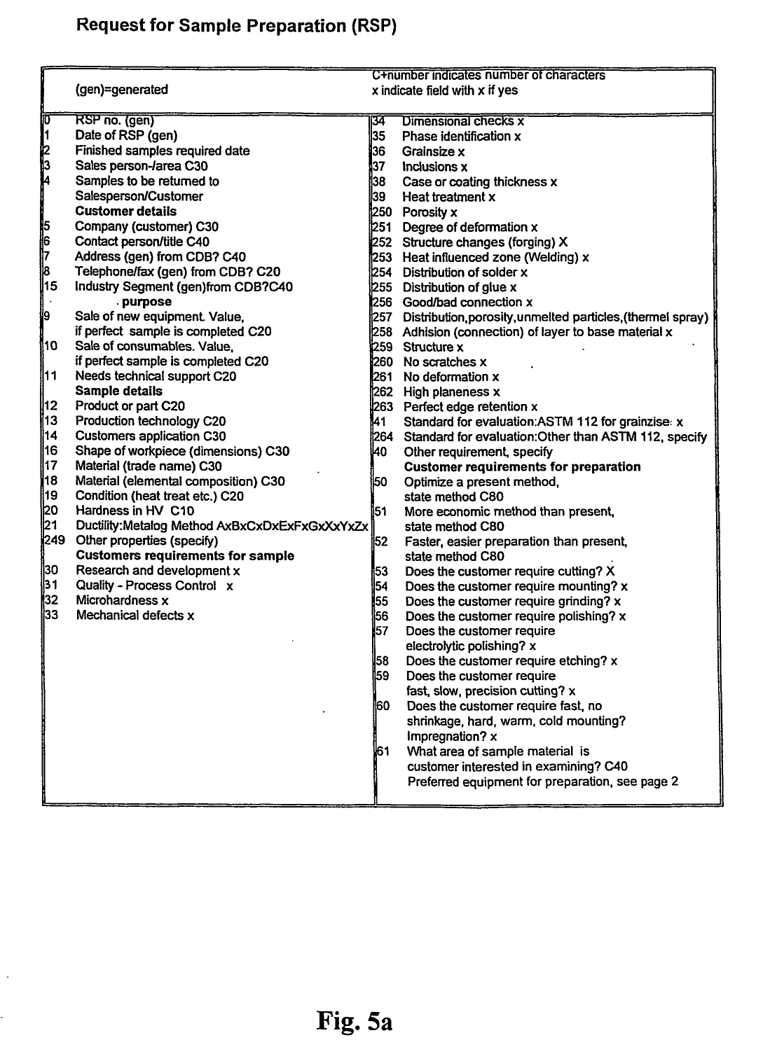

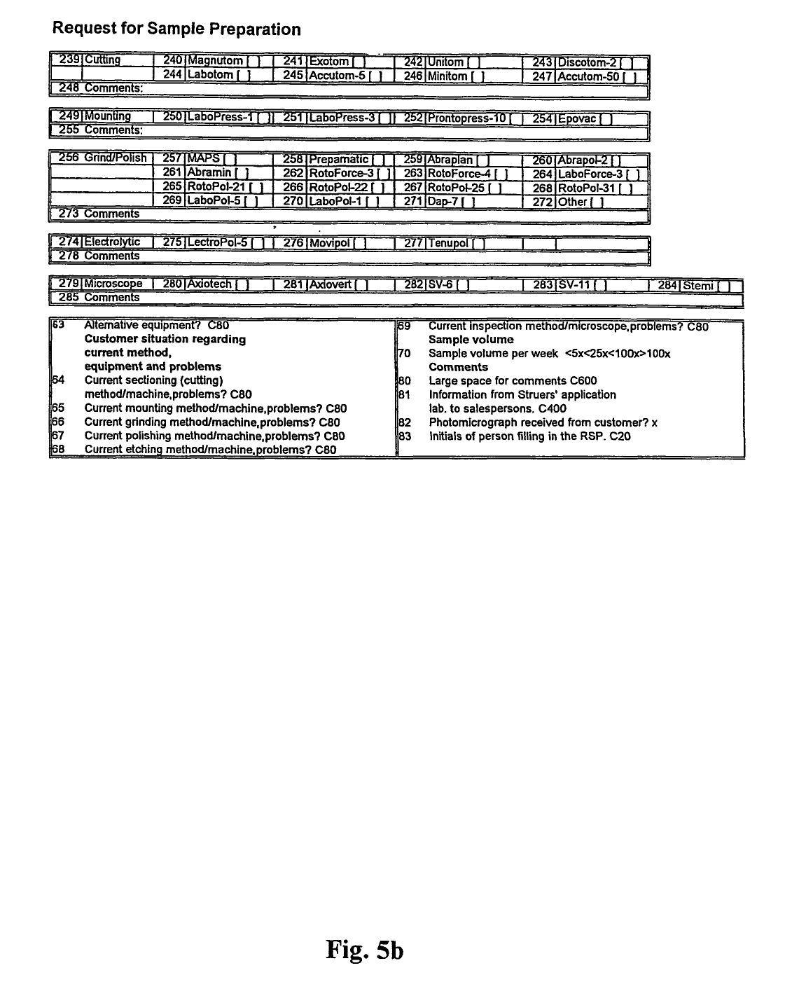

FIGS. 5a and 5b show the fields of the request for “sample preparation” forms according to the second embodiment of the invention;

FIG. 5a shows a first “request for sample preparation” form;

FIG. 5b shows a second request for sample preparation” form;

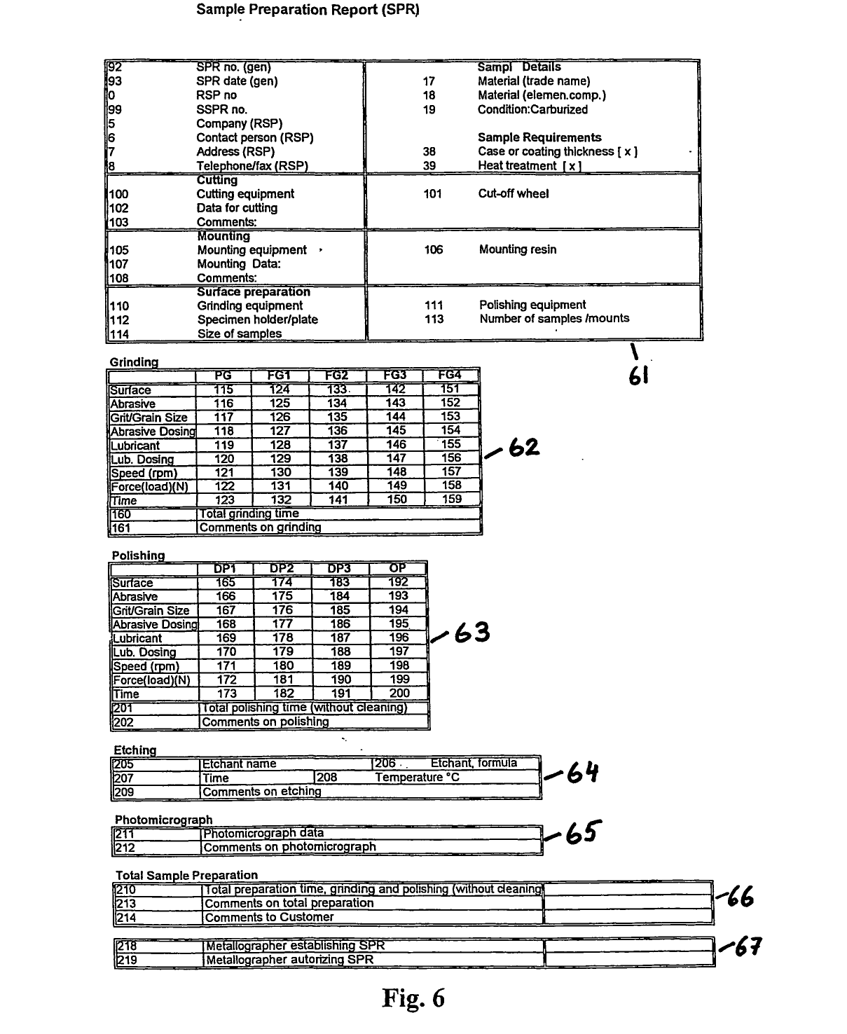

FIG. 6 shows the fields of a first example of a “sample preparation report” according to the second embodiment of the invention;

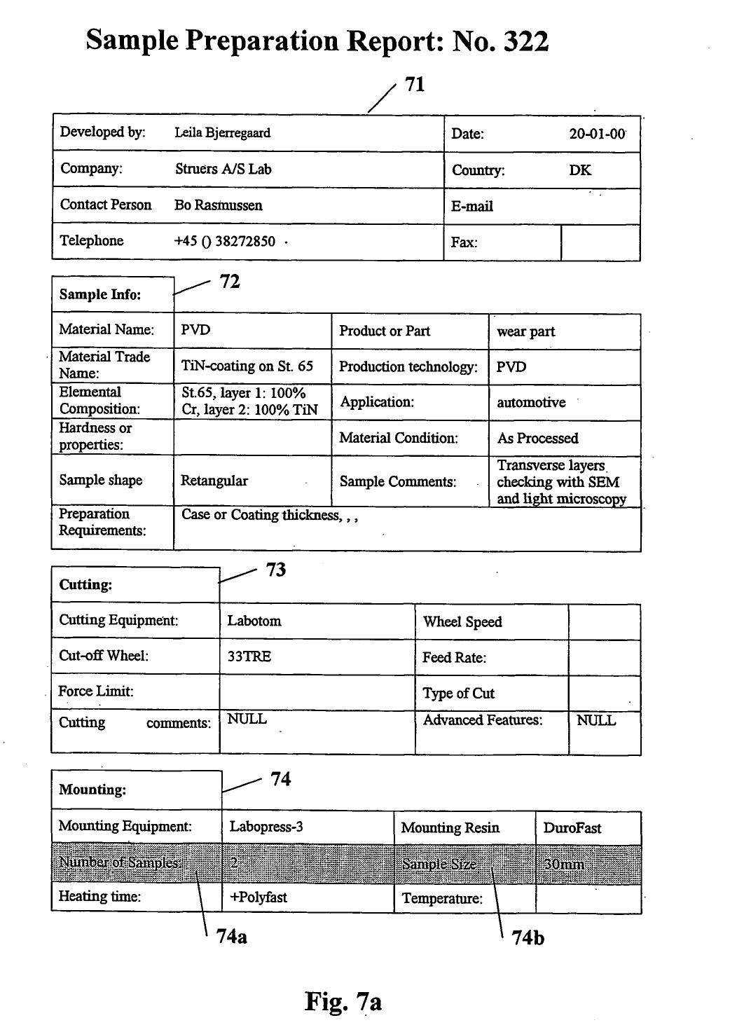

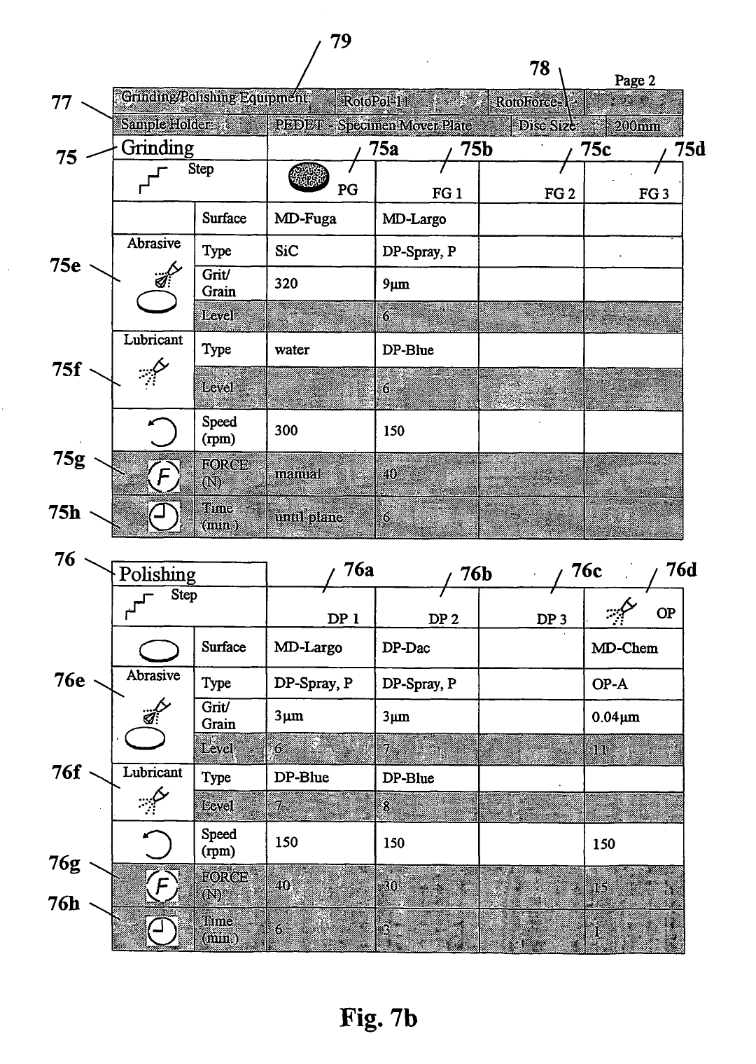

FIGS. 7a and 7b show a second example of a “sample preparation report” according to the second embodiment of the invention;

FIG. 7a shows the first page of the “sample preparation report”;

FIG. 7b shows the second page of the “sample preparation report”; and

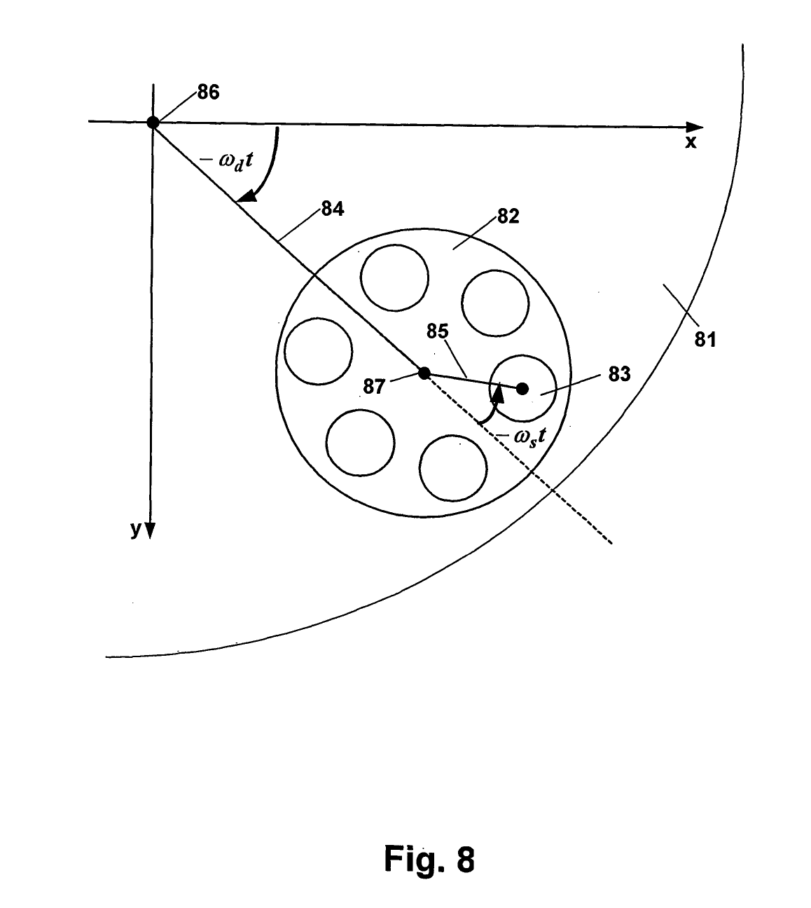

FIG. 8 shows an example of process parameters for the polishing of a sample.

Referring to FIG. 1, a first embodiment of the invention comprises a local server computer 1 at a local site. The server 1 hosts a local database 2, preferably a relational database which may be queried by a query language such as SQL. The data may be physically located on a storage medium, such as a hard disk or a CD, to which the server 1 has access. The server further comprises a processing unit 3, for example the CPU of the computer adapted by a suitable server program. The local server 1 is connected, via a local area network (not shown), to one or more workstations 4a-b, such as standard PCs running a client application. Alternatively, the, server may be connected via any other communications network to other computer equipment, such as a laptop computer connectable via a dial-up connection to the local server, or an input terminal of a sample preparation machine, such as equipment for grinding, polishing or the like. Instead of a local server connected to a plurality of input terminals, a single computer with a display screen, a keyboard and a pointing device may also be used. From one of the workstations 4a, an authorised user inputs input parameters for the requested preparation method, preferably via a set of forms or dialogs provided by a client program. The input parameters are sent to the processing unit 3 of the local server 1. A computer program running on the processing unit 3 of the server 1 performs suitable queries in the local database 2 in order to retrieve generic method parameters corresponding to the input parameters. The generic method parameters may then be adapted to the available equipment specified in the input parameters. This adaptation may include a calculation of parameters such as processing speed, force, processing time, lubrication level or the like. The resulting calculated parameters are then displayed on the screen of one of the workstations 4a, printed, or made available to the user in any other suitable way.

The user, typically a metallographer, then uses the method for the preparation of one or more samples using suitable equipment 5, such as known equipment for grinding, polishing, etc. If applicable, the user may adapt the method, for example in order to cater for samples of a type which has not previously been analysed.

If the user has adapted the method, he or she may input the adapted method parameters together with the sample characteristics and the sample requirements into one of the workstations 4b via a user interface provided by the client software. The adapted method parameters are stored in the local database 2. Alternatively, the same workstation 4a used for entering the original parameters may be used for inputting the updated parameters.

The local server 1 is connected via a communications network, for example a virtual private network, a local or wide area network or any other suitable network, to a central server (not shown) with a central database 6, which may be connected to a plurality of other local sites. At regular intervals, the central database 6 updates the local database 2 with new and changed methods. The preferred update frequency depends upon the typical number of updates and may for example be once a day, or once a week. The updates are preferably performed by standard replication mechanisms of the database system used. The local database 2 in turn sends any adapted methods, as input by the local users, to the central database 6, where they are stored separable from the standard methods. Via a computer 7, an authorised user may view, edit and organise the adapted methods from different local sites. If approved, the adapted methods may be stored as standard methods in the central database 6. Alternatively, the access to the management of adapted methods may also be possible from one of the local workstations 4a-b subject to a suitable access control.

Now referring to FIG. 2, a method for determining sample preparation parameters according to a second embodiment of the invention comprises the step of receiving 21 the necessary input. The input, a “request for sample preparation”, as exemplified in FIGS. 5a and 5b, comprises sample parameters, objectives and equipment data. The sample parameters describe the characteristics of the sample to be prepared, the objectives describe which sample requirements should be fulfilled by the preparation, and the equipment data describes which equipment is available at the corresponding site. Based on the input data, the method database 22 is queried 23 at least once. The query may either result in a specific method for the desired purpose or a generic method which matches the input criteria as well as possible. In a subsequent step 24 of calculating method parameters, the generic method may be adapted to the available equipment by calculating suitable parameters, as will be described in connection with FIGS. 7a and 7b. In the next step 25, the resulting method is presented to the user, for example as a sample preparation report, examples of which are shown in FIGS. 6, 7a and 7b. In a final step 26 the sample is prepared according to the calculated method.

Now referring to FIG. 3, a method for adapting sample preparation parameters according to a second embodiment of the invention comprises the step 31 of preparing a sample. During the step of preparing the sample the preparation method may be adapted in order to cater for the specific sample characteristics, sample requirements or the available equipment. In the next step 32 the adapted set of parameters is received as an input provided by a user and subsequently stored 33 in a local method database, separable from the standard methods. The adapted method data is then transmitted 34 over a communication network to the central database, where it is subject to approval 35 by an authorised expert. In case of approval, the method is stored 36 in the central database as a standard method, and the local database is updated 37. If the adapted method is not suitable as a standard method, for example because it relies upon specifics of a certain laboratory, it is not stored as a standard method in the central database, and is therefore not available to other local sites via regular updates. However, it may still be used as a local method at the site which developed the adapted method.

Now referring to FIG. 4, a system according to a second embodiment of the invention comprises a central Web server 41 hosting a central database. Alternatively, the Web server may be connected to a separate database server, for example via a local area network. The database comprises generic method data, which may be searched and downloaded over the Internet 42 by a local client PC 43 with access to the Internet 42, either directly or via a local network. On the client computer 43 a special client application is running, which provides a user interface to a user and, based on the user's input, searches the central database on the central web server 41 and downloads generic method data. Then the client application converts the generic method data to specific method parameters, corresponding to the selected equipment 45a-b. This step may require further input of specific configuration parameters of the specific machine 45a-b. The specific configuration parameters may comprise the type of polishing material, grinding paper or diamond pad or the size of cutting wheels used. Alternatively, the calculation of specific sample parameters may be performed on the central server 41. After conversion of the method parameters, the specific parameters are sent via a local area network 44 to the selected equipment, which is also connected to the local area network. Instead of a local area network other data connections may be used, such as a serial connection, wireless connections or the like. The preparation of the sample and the control of the equipment may also be controlled via the client computer 43. Alternatively, the client computer may be an integrated part of one of the machines used for sample preparation.

Referring to FIGS. 5a and 5b, an example of the fields contained in a “request for sample preparation” (RSP) according to the second embodiment of the present invention may be used by a manufacturer of sample preparation equipment to manage preparation requests from different customer support sites. The fields shown may be presented in different dialogs, some of the fields are required and others are optional, some fields require text input, others just present a number of choices, such as YES/NO. Each field has a field identifier, indicated by numbers in FIGS. 5a and 5b.

FIG. 5a shows a first form of the RSP which comprises general data, such as an RSP identification, date, etc., it comprises customer details, sample details, and requirements for the prepared sample and the preparation process, respectively.

FIG. 5b shows a second form of the RSP which comprises data concerning the available or desired equipment and possible alternatives.

Referring to FIG. 6, the output of the method according to the second embodiment of the invention, as illustrated in FIG. 2, is a sample preparation report. The report may contain a variety of fields, where each field has a unique identifier. The layout of the reports may be customised and it may be viewed on the screen of a computer or printed out. A first group of fields 61 comprises general data regarding the requesting user, sample data, and general equipment data. The groups 62-64 comprise fields with details for different processing steps. Group 62 allows the specification of up to 4 grinding steps, group 63 allows the specification of up to 4 polishing steps and group 64 specifies a possible etching step. The limitation to a specific maximum number of steps and the specific choice of parameters, however, are no limitations of the invention but merely examples. Group 65 allows the inclusion of a photomicrograph of a prepared sample, while group 66 provides information about the total processing time. Finally, group 67 identifies the metallographers who established and approved the method, respectively.

Now referring to FIGS. 7a and 7b, the method parameters calculated according to the second embodiment of the invention may be calculated on the basis of a generic method stored in the method database 22, where the method parameters are adapted to the specific process, for example the available equipment, by calculating suitable parameters. FIGS. 7a-b show the two pages of a sample preparation report containing the method parameters calculated on the basis of a generic method or on the basis of another specific method. The report contains header information 71, sample information 72 and a number of tables specifying relevant parameters for a number of processing steps including cutting 73, mounting 74, grinding 75, and polishing 76. The steps of grinding 75 and polishing 76 are further split up in a number of sub-steps 75a-d and 76a-d, respectively. Each sub-step is represented by a column in the respective table. The parameters of the shaded fields of the report are calculated on the basis of the generic method and depend on process specific parameters, such as the specific equipment available. For example, the grinding time 75h, the polishing time 76h as well as the dosage levels of abrasives and lubricants 75e-f and 76e-f, respectively, may depend upon the type of sample holder 77, the disc size 78 and the sample size 74b. The number of samples 74a and the sample size 74b may determine the force during grinding 75g and polishing 76g, respectively. A generic method may include default values for the respective parameters, which give the desired results for a default choice of processing equipment.

In the following, a few examples of how actual parameters may be calculated on the basis of a generic method will be described in connection with FIG. 8. A sample preparation device according to the invention may be a polishing apparatus comprising a polishing pad or disc 81 and a sample holder 82.

The sample holder 82 is pressed towards the grinding or polishing pad 81 by a force F. The optimum force depends on the contact area between the samples 83 and the polishing or grinding pad 81. However, the force may only be increased to a given level, which is specific for the type of polisher or grinder. Hence, given a generic method with a value Fₒ for the force on the samples, the force F may be calculated by using the following equation

$$F = \{ \begin{matrix}{F}_{o} \cdot A / {A}_{o} , & if & {F}_{o} A / {A}_{o} < {F}_{max} \\ {F}_{max} , & if & {F}_{o} A / {A}_{o} \geq {F}_{max}\end{matrix} \} ,$$

where A is the contact area between a sample 83 and the polishing or grinding pad 81, Aₒ is a standard contact area used in the generic method, and Fₘₐₓ is an apparatus specific value indicating the maximum obtainable working pressure.

The main factor determining the appropriate time T for each step is the distance D_{work} of the relative movement between the sample 83 and the polishing pad 81. This distance may be calculated from a combination of the polishing or grinding pad diameter D, the sample size Dₛₐₘₚₗₑ, the rotational velocity ωₛ, the geometry SHG of the sample holder 82, the position P of the sample holder 82 over the polishing or grinding pad 81, as well as the rotational velocity ω_{d} of the pad 81. The history of the polishing or grinding pad i.e. the wear situation may also be of importance. Preferably, if the above-mentioned force F has been calculated to Fₘₐₓ, an additional time factor T_{f} is added. Hence, the time T may be calculated from

T=Tₒ·T_{f}H·D_{work}(SHG, D, Dₛₐₘₚₗₑ, ωₛ, ω_{d}, P)/D_{work,o},

where Tₒ is the time of the generic method, T_{f} is the additional time factor taking into account the force F, e.g.

$${T}_{f} = \{ \begin{matrix}1 , & if F < {F}_{max} \\ {F}_{o} \cdot A / ( {F}_{max} \cdot {A}_{o} ) , & if F = {F}_{max}\end{matrix} ,$$

D_{work} is the distance of the relative movement between the sample 83 and the polishing or grinding pad 81. D_{work,o} is the corresponding distance in the generic method. SHG depends on the sample holder geometry and comprises the distance 85 from the centre of the sample holder 82 to the samples 83, D is the diameter of the polishing or grinding pad 81, Dₛₐₘₚₗₑ is the sample diameter, ωₛ is the rotational velocity of the sample holder 82, ω_{d} is the rotational velocity of the pad 81, P is the position of the sample holder 82 over the polishing or grinding pad 81, and H is a factor depending on the history of the polishing or grinding pad 81. It is noted that, for samples with non-circular contact area, an equivalent weighted diameter may be calculated instead of Dₛₐₘₚₗₑ.

In the example shown in FIG. 8, the sample holder comprises six samples 83, where each sample is placed at a distance 85 from the centre 87 of the sample holder 82. 30. The distance 85 may be denoted r and is related to the sample size Dₛₐₘₚₗₑ. The centre 87 of the sample holder 82 may be at a distance 84 from the centre 86 of the polishing disc 81. This distance 84 may be denoted R. The polishing disc 81 may rotate clockwise around its centre 86 with a rotational velocity of ω_{d}, and the sample holder 82 may rotate counter clockwise around its centre 87 with a rotational velocity of CD5. Therefore, the time-dependent x- and y-components of the velocity vector of the sample may be obtained by the following expression

vₓ(t)=ω_{d}·R·sin(ωₛt)

v_{y}(t)=r·(ωₓ−ω_{d})−ω_{d}·R·cos(ωₛt).

As mentioned above, the polishing result for a given sample depends on the total distance the sample 83 is moved over the polishing medium on top of the polishing disc 81. Hence, the preparation time depends on the length of the velocity vector. Thus, from a known preparation time in a generic method with a default size of the polishing disc 81 and a default geometry and size of the sample holder 82, the preparation time for another choice of polishing disc 81 and sample holder 82 may be calculated using the above expressions.

It is noted that the above time-expression may often be approximated by:

T=Tₒ·D_{work}/D_{work,o}

Other examples of parameters which may be determined include dozing levels of lubricants and abrasives. The optimum dozing levels may depend on a number of input parameters including, for example, the diameter of polishing or grinding pad, the rotational velocity, the sample area, and the history of the polishing or grinding pad. Furthermore, the weighting of the parameters may depend on the type of lubricant or abrasive and the type of polishing or grinding pad. Finally, local conditions such as temperature and humidity may also influence the appropriate levels.

The above examples are preferred embodiments of equations. However, other types of expressions may equally well be used for the interpolation of the above and/or other preparation parameters. Furthermore, additional or alternative inputs may be taken into account, such as the preferred surface finish. It is further understood that a person skilled in the art may adjust the above-mentioned equations.

The above examples illustrate the basic principles of interpolating preparation parameters. A further refinement taking into account synergy effects and/or cross-related effects, such as the increased effect of changing both the diameter of the polishing pad and the rotational velocity, may be incorporated into these equations without changing the scope of the present invention.

Further examples of methods for interpolating preparation parameters include the use of neural networks, fuzzy logic, or equivalent approaches.

Some of the input parameters in the above equations may be suggested either by the operator or by a computer program implementing the above methods. An example of such an input parameter is the rotational velocity. For most grinders and polishers the rotational velocity is fixed at for example 150 rpm, however, the rotational velocity may for some types of equipment be switched between 150 and 300 rpm or even continuously from 0 to maximum (for example 300 or higher). In this case, the program will typically prefer to use as high rotational velocity as possible to reduce operation time, however, the operator may choose to reduce the velocity if this is preferred. It is further noted that, according to one embodiment of the invention, the above expressions for interpolating preparation parameters may be used for adapting generic methods to customer-specific circumstances. The generic methods stored in a database are based on a standard choice of equipment. When the customer-specific equipment, e.g. a different type of grinding or polishing machine, a different type or geometry of grinding or polishing pad, a different sample geometry, etc., is specified, the generic method parameters may be interpolated yielding a specification of a customer-specific method.

1. A system for determining sample preparation parameters for use in a preparation of a sample of a material, the preparation comprising the use of at least one sample preparation device (5), the system comprising
first input means (4a) for receiving input values for a set of preparation criteria;
first storage means (2,6,22) adapted to store a plurality of preparation criteria and a plurality of sample preparation method parameters;
processing means (3) adapted to determine a set of sample preparation method parameters based on the input values and the stored sample preparation method parameters; and
output means (4a) adapted to output the determined set of sample preparation method parameters;
characterised in that the system further comprises
second input means (4b) for receiving adapted sample preparation method parameters; and
second storage means (2) adapted to store the adapted sample preparation method parameters for subsequent retrieval by the processing means in connection with a subsequent determination of sample preparation method parameters requested by an authorised operator.

2. The system according to claim 1, characterised in that the set of preparation criteria comprises a set of sample properties and identifications of the sample preparation device.

3. The system according to claim 2, characterised in that the sample properties comprise quality requirements for the prepared sample.

4. The system according to any one of the claims 1 through 3, characterised in that the sample preparation method parameters comprise process step identifications, sample preparation device identifications and process parameters.

5. The system according to any one of the claims 1 through 4, characterised in that the second input means is further adapted to receive adapted preparation criteria, and the second storage means is adapted to store the adapted preparation criteria.

6. The system according to any one of the claims 1 through 5, characterised in that the system further comprises editing means (7) adapted to allow an authorised user to edit at least the adapted sample preparation method parameters stored in the second storage means and to store the edited sample preparation method parameters in said first storage means.

7. The system according to any one of the claims 1 through 6, characterised in that said sample preparation device (45a, 45b) is connected to said output means via a communication interface (44) and adapted to receive said calculated sample preparation method parameters.

8. The system according to any one of the claims 1 through 7, characterised in that the system comprises a server data processing system (1, 41) and a client data processing system (4a, 43) connected via a communications network (42), the client data processing system including the first input means, the output means, and means for sending a request to the server data processing system via the communications network, the request comprising the input values; and the server data processing system including the first storage means and the processing means.

9. The system according to any one of the claims 5 through 8, characterised in that the client data processing system further comprises the second storage means.

10. The system according to any one of the claims 1 through 9, characterised in that the processing means is adapted to interpolate between the sample preparation method parameters stored in said first storage means.

11. A method of determining sample preparation parameters for use in a preparation of a sample of a material, the preparation comprising the use of at least one sample preparation device, the method comprising the steps of
receiving (21) input values for preparation criteria;
determining (24) a set of sample preparation method parameters based on the input values and a plurality of sample preparation method parameters stored in a first storage means (22);
outputting (25) the set of sample preparation method parameters on a first output means;
characterised in that the method further comprises the step of storing (33) an adapted set of sample preparation method parameters in a second storage means for subsequent retrieval in connection with a subsequent determination of sample preparation method parameters requested by an authorised operator.

12. The method according to claim 11, characterised in that the method further comprises the steps of
processing (35) the second set of sample preparation parameters by a supervisor; and
storing (36) the processed set of sample preparation method parameters in the first storage means.

13. The method according to any one of the claims 11 and 12, characterised in that the set of preparation criteria comprises a set of sample properties and identifications of the sample preparation device.

14. The method according to claim 13, characterised in that the sample properties comprise quality requirements for the prepared sample.

15. The method according to any one of the claims 11 through 14, characterised in that the sample preparation method parameters comprise process step identifications, sample preparation device identifications and process parameters.

16. The method according to any one of the claims 11 through 15, characterised in that said sample preparation device is connected to said output means via a communications interface and adapted to receive said calculated sample preparation method parameters.

17. The method according to any one of the claims 11 through 16, characterised in that the step of calculating a first set of sample preparation method parameters comprises the step of interpolating between a plurality of the sample preparation method parameters stored in said first storage means.

18. A server data processing system for determining sample preparation parameters for use in a preparation of a sample of a material, the preparation comprising the use of at least one sample preparation device, the server data processing system comprising
means for receiving a request from a client data processing system via a communications network, the request including input values for a set of preparation criteria;
first storage means adapted to store a plurality of preparation criteria and a plurality of sample preparation method parameters;
processing means adapted to determine a set of sample preparation method parameters based on the input values and the stored sample preparation method parameters; and
means for sending a response to the client data processing system including the determined set of sample preparation method parameters;
characterised in that the server data processing system further comprises
means for receiving a request including adapted sample preparation method parameters; and
second storage means adapted to store the adapted sample preparation method parameters for subsequent retrieval by the processing means in connection with a subsequent determination of sample preparation method parameters requested by an authorised operator.

19. A server data processing system according to claim 18, characterised in that the server data processing system further comprises editing means adapted to allow an authorised user to edit at least the adapted sample preparation method parameters stored in the second storage means and to store the edited sample preparation method parameters in said first storage means.

20. A client data processing system for determining sample preparation parameters for use in a preparation of a sample of a material, the preparation comprising the use of at least one sample preparation device, the server data processing system comprising
first input means for receiving input values for a set of preparation criteria;
means for sending a request to a server data processing system via a communications network, the request including the input values;
means for receiving a response from the server data processing system including a set of sample preparation method parameters determined based on the input values as well as a plurality of preparation criteria and a plurality of sample preparation method parameters stored in a first storage means of the server data processing system;
characterised in that the client data processing system further comprises
second input means for receiving adapted sample preparation method parameters; and
second storage means adapted to store the adapted sample preparation method parameters for subsequent retrieval by the processing means in connection with a subsequent determination of sample preparation method parameters requested by an authorised operator.
